(19) United States
(12) Patent Application Publication
(10) Pub. No.: US 2006/0039554 A1
(43) Pub. Date: Feb. 23, 2006

(54) High security media encryption

(75) Inventor: Gregory P. Fry, Portland, OR (US)

Correspondence Address: MARTINE PENILLA & GENCARELLA, LLP, 710 LAKEWAY DRIVE, SUITE 200, SUNNYVALE, CA, 94085, US

(73) Assignee: Roxio, Inc., Santa Clara, CA (US)

(21) Appl. No.: 10/921,367

(22) Filed: Aug. 18, 2004

(51) Int. Cl. H04L 9/06

(52) U.S. Cl. 380/29

(57) ABSTRACT

A method for encrypting a block-based removable media includes identifying a file system for the media, and receiving a selection of data to be written to the media. The identified file system designates specific logical block addresses for file system structures and files which enable the media to mount and enable the locating of recorded data on the media. When recording the block-based removable media, logical block addresses for blocks containing both file system structures and files as well as blocks containing the selection of data are randomized throughout the block based removable media. A decryption key is required to first locate the file system and enable the media to mount, and ultimately to locate and access the selection of data recorded thereon.

### BACKGROUND OF THE INVENTION

1. Field of the Invention

The present invention relates generally to data encryption, and more specifically to security of data on block-structured media organized by a file system.

2. Description of the Related Art

Encryption of data is fairly commonplace. Algorithms have proliferated to encrypt files, programs, databases, etc., in locations as disparate as a local hard drive, Internet and Intranet locations, email transmissions, and so forth. Removable media, including CD and DVD media, and even the older floppy disk, is routinely encrypted as well, and while current methods of encryption are usually software based (i.e., a software application encrypts data as the data is written to the media), the technology of encryption methods and apparatus continues to evolve.

In the case of optical media such as CD and DVD, data is typically structured and formatted on the media in accordance with a plurality of standards and specifications in order to create media that is compatible with and can be accessed by the variety of consumer electronic devices ranging from personal computers having various operating systems, to audio and visual playback devices for personal, portable, or home entertainment, etc., use and enjoyment of the audio, visual, or other data recorded to the optical media. The published standards and specifications, therefore, enable reliable and compatible media. Such standards as the “Blue,” “Red,” “Orange,” and “Yellow” Books, ISO9660, Universal Disc Format (UDF), etc., are all well known in the art and variously describe the structure and format of data on the applicable media.

In defining the structure and format of data on media, standards and specifications further describe file systems and associated structures. By way of example, an audio media may be structured and formatted as an audio disc in accordance with one specification, data may be written to a CD in accordance with one or more specifications, data may be written to a DVD in accordance with one or more specifications, and so forth. A plurality of file systems have been defined, and are selected or implemented according to particular criteria, and media can be written with one or more file systems implemented thereon. By way of example, a data CD can have both ISO9660 and UDF file systems on the same media. Certain file systems, however, will more likely than not be implemented on specific types of media.

Removable media, and in particular optical media such as CD and DVD media, whether the media is recordable or rewritable, is generally structured in sectors. That is to say, the media is physically structured in subdivisions of sectors of a given size or capacity. By way of example, a CD media might be subdivided into sectors having a capacity of 2352 bytes. Media are typically formatted in tracks, sessions, and other known methods of grouping, arranging, or formatting data written to the media.

When data is encrypted, a key is typically provided with which to encrypt all the data written to the media. In accordance with customary practice, as each block of data is written to the media, the key is used to encrypt the data before writing the block, and then the encrypted data is written to the media. The same key is then required to decrypt and retrieve or access data written to the media. FIG. 1 is a schematic 10 graphically illustrating the typical encryption/decryption process. Data from a source 12 is obtained by an application that will write the data to a target block-structured media, which in the illustrated example is a CD media 16. The obtained data is encrypted 14 using a key 15 and then written to the target CD media 16. In order to read, retrieve, or otherwise access the data written to the CD media 16, the data on the CD media 16 must be decrypted 18 using the same key 15 that was used to encrypt 14 the data. Once decrypted 18, the data 20 is then accessible.

As is known, the encryption/decryption key 15 can range in complexity from elementary to extremely sophisticated and complex, providing a corresponding range in security of data sought to be encrypted. While the complexity of the key used may provide varying levels or degrees of security of the raw data, a comparison of encrypted and decrypted data might be all that is required to “break the code” and provide the necessary information to decrypt and read any and all data so encrypted.

In view of the foregoing, what is needed is a method of data encryption that provides a greater degree of security than that which is currently implemented. Specifically, removable media should be capable of easily being encrypted, and decrypted, while affording a maximum degree of security.

### SUMMARY OF THE INVENTION

Broadly speaking, the present invention fills these needs by providing methods and systems for encryption of removable, sector-based media. The present invention can be implemented in numerous ways, including as a process, an apparatus, a system, a device, a method, or a computer readable media. Several embodiments of the present invention are described below.

In one embodiment, a method for encrypting a block-based removable media is provided. The method includes receiving a selection of data to write to the block-based removable media. The method provides for identifying true logical block addresses on the block-based removable media to which the selection of data will be associated, and for assigning encrypted logical block addresses according to a first encryption algorithm. The encrypted logical block addresses have corresponding unencrypted true logical block addresses. The method further provides for writing the selection of data to the block-based removable media. The writing of the selection of data is to the encrypted logical block addresses. When the selection of data is located on the block-based removable media according to the true logical block addresses, the block-based removable media is enabled to provide access to the selection of data recorded thereon.

In another embodiment, a method for encrypting a block-based removable media is provided. The method includes identifying a file system for the block-based removable media, and identifying a selection of data to write to the block-based removable media. The method then provides for identifying physical block locations on the block-based removable media to which the file system and the selection of data will be associated. The physical block locations are identified according to the identified file system. Next, the method provides for assigning encrypted physical block locations according to a first encryption algorithm with each physical block location identified for the file system and the selection of data corresponding to an encrypted physical block location. Then, the method provides for writing the file system and the selection of data to the block-based removable media. The writing is to the encrypted physical block locations. When the file system and the selection of data are located according to the physical block location, the block-based removable media is enabled to provide access to the selection of data recorded thereon.

In a further embodiment, computer readable media having program instructions for encrypting removable media is provided. The computer readable media includes program instructions for preparing a selection of data to write to the removable media, and program instructions for identifying true logical block addresses on the removable media to which the selection of data will be associated. The computer readable media further includes program instructions for assigning encrypted logical block addresses according to a first encryption algorithm with each true logical block address identified for the selection of data corresponding to an encrypted logical block address, and program instructions for writing the selection of data to the removable media. The writing of the selection of data is to the encrypted logical block addresses. When the selection of data is located according to the true logical block addresses, the removable media is enabled to provide access to the selection of data recorded thereon.

In still a further embodiment, a method for encrypting data written to optical media is provided. The method includes receiving a selection of data to write to the optical media, and identifying true logical block addresses on the optical media to which the selection of data will be associated. The method further includes defining encrypted logical block addresses according to a first encryption algorithm. The encrypted logical block addresses have corresponding unencrypted true logical block addresses. The method then provides for writing the selection of data to the optical media. The writing is to the encrypted logical block addresses. The method further provides for identifying the optical media as encrypted. The identifying includes defining a field in a first Lead-In of the optical media to identify the optical media as encrypted. When the selection of data is located on the optical media according to the true logical block addresses, the optical media is enabled to provide access to the selection of data recorded thereon.

The advantages of the present invention over the prior art are numerous. One notable benefit and advantage of the invention is that block-based removable media can be encrypted to a greater degree of security than previously available. Since most file systems have essentially constant, pre-defined data structures and files, in specified locations, the determination of the encryption key can be simplified to an examination of encrypted file system blocks. By randomizing essentially all block locations on a removable media, both the file system and the data recorded thereon are scrambled throughout the media, and deducing the decryption key is no longer an elementary exercise, thereby providing a much higher degree of media security than provided in prior art schemes, methods and systems.

Other advantages of the invention will become apparent from the following detailed description, taken in conjunction with the accompanying drawings, illustrating by way of example the principles of the invention.

### BRIEF DESCRIPTION OF THE DRAWINGS

The accompanying drawings, which are incorporated in and constitute part of this specification, illustrate exemplary embodiments of the invention and together with the description serve to explain the principles of the invention.

FIG. 1 is a schematic graphically illustrating the typical encryption/decryption process.

FIG. 2 shows a diagram of a hardware encryption process.

FIG. 3A illustrates a block diagram of a UDF formatted optical media.

FIG. 3B shows a packet of data written to a block-structured, removable media in accordance with one embodiment of the present invention.

FIG. 4 is a flow chart diagram of the method operations performed to encrypt a removable media in accordance with one embodiment of the present invention.

FIG. 5 is a flow chart diagram of the method operations performed to encrypt a removable media in accordance with another embodiment of the present invention.

FIG. 6 is a flow chart diagram illustrating the method operations performed to decrypt data on removable media in accordance with one embodiment of the present invention.

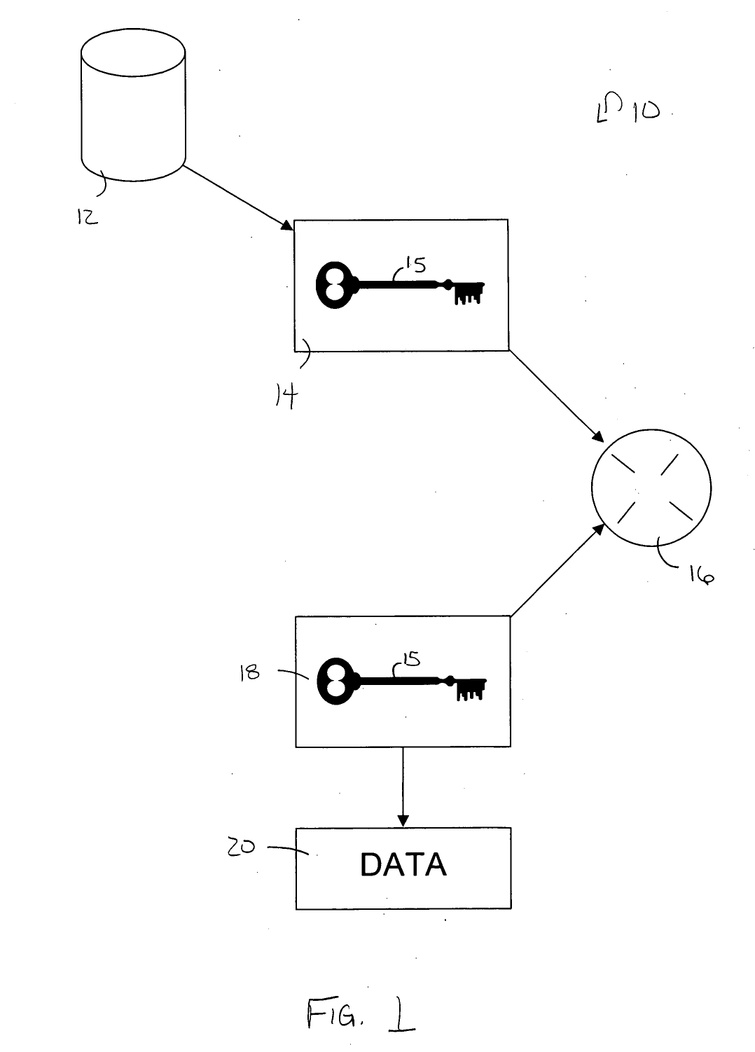

### DETAILED DESCRIPTION OF EXEMPLARY EMBODIMENTS

An invention for media encryption is described. In preferred embodiments, a method of media encryption includes randomizing, or “pseudo-randomizing,” essentially all sectors or blocks on a removable media when recording both the file system and the data to the media. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

As an overview, embodiments of the present invention provide for an order of magnitude of additional complexity to anyone trying to break the encryption of an allegedly secure or encrypted media. If, for example, only file data on a removable media is encrypted, then the file name, and many of the file attributes (file size, last accessed/written date, etc.) are still accessible to unknown parties. Although this information may be inconsequential, particularly compared to the file contents, it can never-the-less allow said unknown parties to deduce or infer information about the contents, as well as to allow other parties to more quickly target which files they may want to obtain or access. To overcome this vulnerability, encryption can be performed on the data in all blocks on the disc. Such comprehensive encryption inhibits the attribute information from being discovered. However, by doing this type of all-encompassing encryption, third parties are inadvertently enabled to more easily “decrypt” the data, also referred to as break the encryption. This is because, in some file-systems, the data contained in certain blocks is well known. By using the expected, unencrypted, data of those certain blocks, and comparing to data contained in its encrypted from, an unknown third party can more easily deduce the encryption key. Thus, using an encryption key to randomize, or “pseudo-randomize” where the file-system blocks are actually stored on the disc makes complete disc encryption significantly more secure.

Removable media is typically structured and organized around a file system in accordance with any of a plurality of internationally recognized standards and conventions governing format and structure applicable to both the removable media itself, as well as to the player and recorder devices used to create and to playback or otherwise access data written to the removable media. The size, capacity, and convenience of removable optical media, for example, has contributed to the overwhelming popularity of CD, DVD, and other optical media as a media of choice for data storage and exchange. Security is an ever-present concern in such an information age, and, as described above, a plurality of security methods and measures have been widely accepted as routine to afford some level of protection for data in general, as well as to achieve security for data recorded to optical media, and to other sector-structured removable media.

In addition to the exemplary software encryption methods described above, methods and systems are further evolving to incorporate hardware based encryption on or in a removable media drive (i.e., a computing chip is incorporated on the media drive to encrypt data as it is written). When data is encrypted by a computer chip implemented in a media drive, for example, a key is used to encrypt all of the file data received by the media drive. As each block of file data is written to the media, the key is used to encrypt the data before writing each block to the media. Similarly, the key is then provided with which the file data is decrypted, one block at a time, in order to read back or otherwise access the data on the removable media.

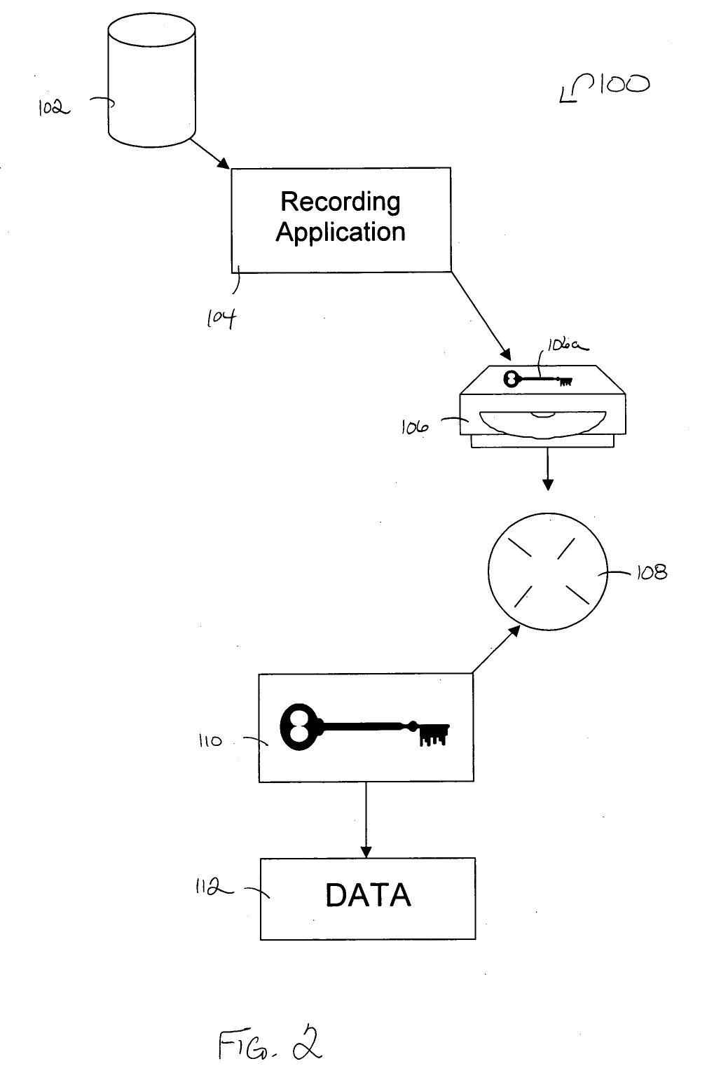

FIG. 2 shows a diagram 100 of hardware encryption as described above. Typically, data is read from a source 102 by a recording application 104 and sent to an optical media recording device 106. Optical media recording device 106 includes an encryption chip 106a that encrypts data and then records the encrypted data to produce encrypted optical media 108. In order to read, playback, or otherwise access the data on encrypted optical media 108, a decryption key 110 is provided to enable access to data 112.

As with software-based encryption described earlier, the degree of security provided by hardware enabled encryption can similarly range from minimal to reasonably secure, depending on the complexity of the encryption algorithm or key used. However, whether the encryption is accomplished by software or hardware, it is generally implemented at the file level in block-structured removable media. That is, generally, as file data is written from a source to a removable media, it is encrypted so that any data retrieved without first decrypting the data is typically unreadable, unusable, or simply garbage. In some cases, file data is encrypted as it is written. File system data, however, is generally not encrypted. A particular file system or systems may be first defined on a recordable removable media, and then any data sent to the media recording device for encrypting and recording, is first encrypted, and then recorded to the device. In other words, the file data sought to be recorded and encrypted on a removable media is encrypted, but the file system, file system structures, etc., which are typically not readily apparent to the average user of removable media, may not be encrypted. For data recorded and encrypted in this manner, the fact that files exist on the encrypted media, and even such information as file names, time and date stamps, file properties, etc., may be discernable, even if the user data itself is encrypted.

Although an encryption algorithm implemented to write encrypted data can be complex, the basic structure of the file system, various structures, and dedicated blocks therein are generally known or knowable. In some methods of encryption, both file data and the file system of the removable media are encrypted. However, as described in greater detail below, the location and structure of the file system on the removable media, even in an encrypted state, remain knowable or decipherable, and therefore the “keys” to the encryption algorithm are accessible, if not readily available. With the ability to break the code or decrypt these known blocks and/or structures comes the ability to decrypt the entire media.

Embodiments of the present invention provide for encrypting data on block structured, also referred to as sector-based, removable media by scrambling or randomizing, also referred to herein as “pseudo-randomizing” the writing of sectors to the media. The term “pseudo-randomizing” is used to reflect that the “randomizing” is accomplished according to an algorithm, and therefore not strictly “random.” In one embodiment, a minimal level or degree of security can be achieved by simply scrambling or pseudo-randomizing (hereinafter “randomizing”) sectors written to the removable media, including the sectors in which the file system is defined. In this embodiment, most removable media would fail to mount, load, boot, etc., (hereinafter “mount”) because required structures and file information are not found or identified on the media as required during the mounting process. In another embodiment, a higher level of security is achieved by first encrypting the file data in accordance with a desired encryption algorithm, and then randomizing the sectors written to the removable media. In this embodiment, most removable media also would fail to mount because required structures and file information are not found or identified on the media as required during the mounting process. Additionally, even if sectors of the media could be analyzed to determine content, the encrypted sectors are garbage without either a decryption key or knowing the content of the sector and thus having the ability to decrypt that sector.

The present invention provides for encryption of data recorded to block-structured removable media. Examples of block-structured removable media include floppy disks, optical media such as CD-R, CD-RW, DVD-RW, DVD+RW, and the like. The terms “media,” and “optical media,” are used interchangeably herein, and should be understood to be representative of all forms of block-structured or sector-based removable media. Embodiments of the present invention are equally applicable to other types of removable media such as a floppy disk. In addition, the terms “track” and “session,” as they apply to CD optical media and as used herein, also are equivalent to the concepts of “zone” and “border” as they apply to DVD optical media.

Block-structured media is typically formatted and structured in accordance with an applicable standard. Specific standards define, for example, specific system, volume, and file structures for particular media. By way of example, a CD media may have a UDF file system, or an ISO9660 file system, or some other file system or combination of file systems defined thereon. Embodiments of the present invention are illustrated in the instant application using the common UDF file system as an exemplary, typical file system. In order for any UDF structured CD optical media to read, play, or otherwise afford access to content on the CD optical media, various structures are written to specific physical locations on the media so that the media will properly mount when inserted into a CD optical media device. Looking at another example, when a DVD media is inserted into a DVD media device, a particular structure or structures in particular locations are searched and must be identified in order for the DVD media to mount. The structure or structures and the location in which the structure or structures are to be written is defined in the DVD-ROM Basic Physical Format specification, which is incorporated herein in its entirety for all purposes.

It should be appreciated that randomizing sectors in accordance with embodiments of the present invention provides a significantly increased degree or level of security over traditional encryption methods. As described above, essentially each specified and standardized file system includes system data blocks that are either predefined, or so nearly predefined that their content is essentially known or knowable. Further, those same system data blocks are defined as specific logic blocks, assigned to a specific physical location or locations on the associated media. Embodiments of the present invention provide for randomizing essentially all sectors on the media so that the physical location or locations of these known system data blocks is unknown absent a first level of decryption to identify the physical location on an encrypted media of these system data blocks. As is known, CD media contains hundreds of thousands of sectors, and DVD media contains millions of sectors.

Returning to a UDF file system on CD media as an illustrative example, specific file system and volume structures are defined in the UDF specification (i.e., Optical Storage Technology Association (OSTA) Universal Disk Format™ Specification, Rev. 1.5), which is incorporated herein by reference in its entirety for all purposes, to be in specific locations so that when a CD optical media is inserted into a CD optical media device or drive, the CD optical media device can identify the CD optical media as a UDF media, mount the volume, and access the data recorded thereon. While UDF is used as an exemplary file system and structure, it should be understood that other file systems have been defined for CD, DVD, and other block-structured removable media. Generally, any file system defines specific files and/or structures in specific locations that are identified and accessed to enable mounting of the media having the file system defined thereon. Examples of UDF file system structures include volume structures such as the Volume Recognition Sequence (VRS), Anchor Volume Descriptor Pointer (AVDP), Primary and Reserved Volume Descriptor Sequences (VDS), Logical Volume Integrity Descriptor (LVID), and the like, as well as a sparing table and pre-initialized space for sparing packets.

In accordance with one embodiment of the present invention, encryption of data written to sector-based removable media is accomplished by randomizing or scrambling the sectors written to the optical media. In this manner, required, specific file system structures that are necessary to identify and mount the removable media would, most likely, not be found in the specified locations on the media. A first level of decryption of the media would be necessary in order to first locate the required structures in order to identify and mount the media.

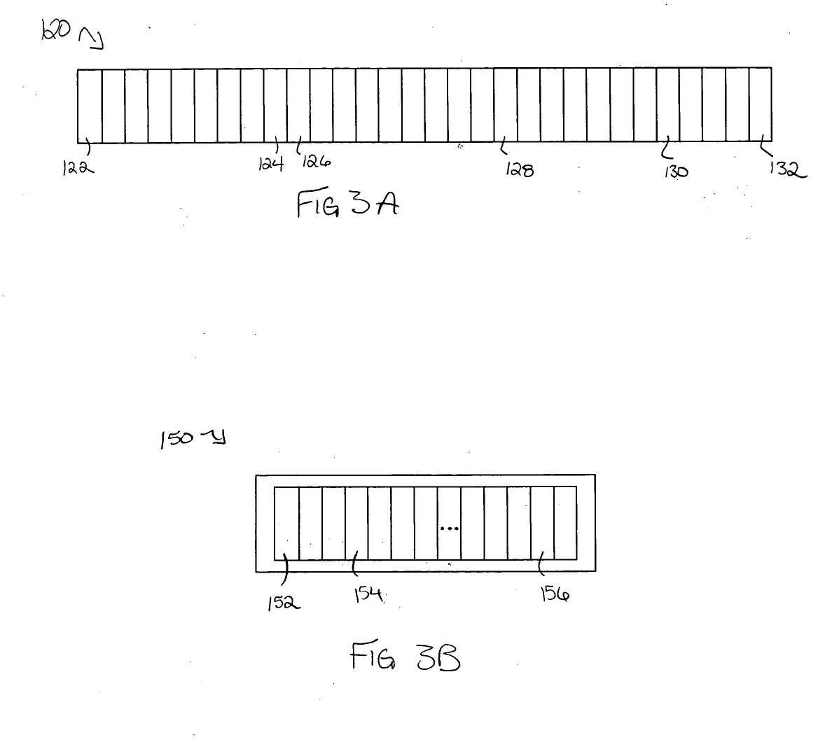

FIG. 3A illustrates a block diagram 120 of a UDF formatted optical media. Block diagram 120 shows blocks or sectors representing the blocks or sectors of an optical media. Block 122, for example, contains a Lead-In section, including a TOC or Table of Contents of the track information of the optical media. Block 124 of block diagram 120 represents block 256 of the optical media. In block 256 of a UDF formatted optical media, the AVDP is written, and so in block diagram 120, block 124 represents the AVDP of the optical media. Often, in UDF formatted media, the VDS is written in the block immediately following the AVDP, and in block diagram 120, the VDS is represented at block 126. As is known, the AVDP is periodically repeated in a UDF formatted media at block 512, as well as the block that is 256 blocks from the end of the formatted media. In block diagram 120, block 128 represents block 512 and a copy of the AVDP, block 132 represents block n, the last formatted block of the media, and block 130 represents block n-256, another block containing a copy of the AVDP.

As is known, the AVDP contains pointers to the locations of the primary and reserve VDS, a length or size of the structure, as well as a 16 byte tag which identifies the block as an AVDP. Since these values are often the same from one disc to another, the AVDP is of a somewhat “standard” structure and content. Although an exact content and structure is not defined by specification, those skilled in the art recognize that the AVDP contains a generally constant and predictable content and structure. The content and structure is sufficiently constant and predictable that an encrypted AVDP can be decrypted with little resource expenditure, and in a fairly short period of time. Similarly, the VDS, while not as constant and predictable in structure and content as the AVDP, is sufficiently constant and predictable to afford ample opportunity for decryption with a high probability of success to achieve a reasonable degree of accuracy, and without having a decryption key or keys. Therefore, a typically encrypted CD media, formatted in UDF in accordance with the present example, is vulnerable to data compromise because either the encryption used does not encrypt the file system which identifies data file attributes and locations of data files on the media, or the file system is encrypted, but known structures in known locations, having sufficiently constant and predictable content and structure, are fairly easy to decrypt, thereby providing the “keys” to the data on the media.

Similarly, block-structured media formatted in accordance with other generally accepted standards typically all contain known or knowable structures in known locations. Other examples include DVD media having a DCB or Disc Control Block, comparable to the TOC of CD media. Further, like CD media, DVD media also contain file system structures in known and specified locations, having a generally constant and predictable structure and content. Even if the file system is encrypted, one skilled in the art generally knows what the file or data structure looks like unencrypted, and with the typically encrypted media, one skilled in the art then knows what the file or data structure looks like encrypted. With the application of elementary encryption/decryption techniques, the key is determined and the media is then simply decrypted. Since a selection of a particular media and the type of data recorded thereon typically lends itself to a particular type, or relatively few types, of formatting, even when the specific standardized format is unknown, the number of standardized formats is small enough to significantly increase the probability of accurately decrypting the media while significantly reducing the amount of time required to decrypt the media

FIG. 3B shows a packet 150 of data written to a block-structured, removable media in accordance with one embodiment of the present invention. As is known, some block-structured removable media is written or recorded to in fixed or variable length packets. Packets may include from one up to a plurality of sectors. Fixed packets containing 32 sectors per packet are typically used on CD-RW media. Fixed packets of 16 sectors per packet are used on all DVD media, by definition. In one embodiment of the present invention, packets of data 150 are randomized with individual sectors maintained in the order in which they are assembled in the packet, and in one embodiment, sectors are randomized within packets. As is known, packet writing, whether fixed or variable length packets, is just a method of writing data to a target removable media, such as a CD optical media. Therefore, in the exemplary UDF formatted CD media, the media remains a UDF formatted media whether or not the media was recorded by packet writing. In one embodiment of the present invention, the randomizing of sectors on the target removable media is modified to accommodate packet writing.

By way of example, one embodiment of the invention provides for first encrypting all data to be written to the sectors in a packet, and then randomizing the sectors within the packet. In this manner, a 32-sector CD-RW media might include data written in packets so that the data is first encrypted, and then the 32 sectors of each packet are randomized, but grouped as the same packet of data that would be written if the data were not encrypted. In one embodiment, the packets are written to the disc in the same order, and with the same content, as if the 32 packet sector were not encrypted. The randomization would be according to an encryption key. In another embodiment, each and every sector to be written to a disc is randomized according to an encryption key. In still another embodiment, sectors within a packet are randomized, and then packets written to the media are randomized. In other words, a sector's relative location within the packet is randomized in addition to the packet's location on the media, all according to an encryption algorithm Additional complexity, and corresponding system burdens, can be added by first encrypting the data before randomizing sectors' and/or packets' locations.

Data packet 150 in FIG. 3B is a packet of data of the exemplary UDF formatted CD optical media. Block 152 represents block 256 of the UDF formatted media, the AVDP, and blocks 154 through 156 represent the VDS. FIG. 3B is not drawn to any particular scale, and the number of “sectors” illustrated are representative of any number of sectors according to the type of media, etc. A data packet 150 does not include all of the sectors of the media, but only from one to a plurality.

In one embodiment of the invention, the desired level of security is achieved by randomizing (via the encryption key) sectors within data packets 150, and then randomizing (via the encryption key) where the entire packet is written, which achieves a similar result as individual sector randomizing. In other words, the media would remain incapable of mounting if block 256 and the AVDP could not be located, for example. In this embodiment, the number of sectors that define a data packet 150 for a particular device or system will define the number of sectors that will be randomized as units on the removable media. For example, if data packet 150 is defined by 16 sectors, when sectors 10,123-10,138 are written as a data packet 150 to a removable media, they might actually be written to sectors 426-441, or any other sixteen consecutive sectors, on the media. Even though from one to a plurality of sectors that define a packet are written together as a continuous, consecutive unit, the units of sectors, the data packets 150, are randomized when written to the removable media, achieving the desired degree of data security.

From the above discussion, it should be appreciated that randomizing is according to a particular encryption algorithm or key. In one embodiment, an encryption algorithm or key is applied to a logical block address for each sector to calculate or determine a new or encrypted logical block address where the sector is actually written. This, essentially, provides a map, table, or calculation so that each un-encrypted or true logical block address corresponds to an “encrypted” logical block address. The “encrypted” logical block addresses are simply those logical blocks to which the sectors of data are written as determined from the application of an algorithm or key to the true logical block addresses to which the data would ordinarily be written. The map, table, or calculation can define locations of individual sectors, and it can define groups or units or sectors, i.e., the sectors written as a unit in packets. If, for example, the unencrypted or true sector 256 is to be located (in order to mount the media), the encryption algorithm or key is applied to logical block address 256 to determine the encrypted logical block address where the sector was actually written. Decryption, then, is the reverse. That is, if the encryption algorithm or key maps each unencrypted logical block address to an encrypted logical block address, then the encryption key or algorithm is used to determine or calculate the true or unencrypted logical block address for each sector of an encrypted disc.

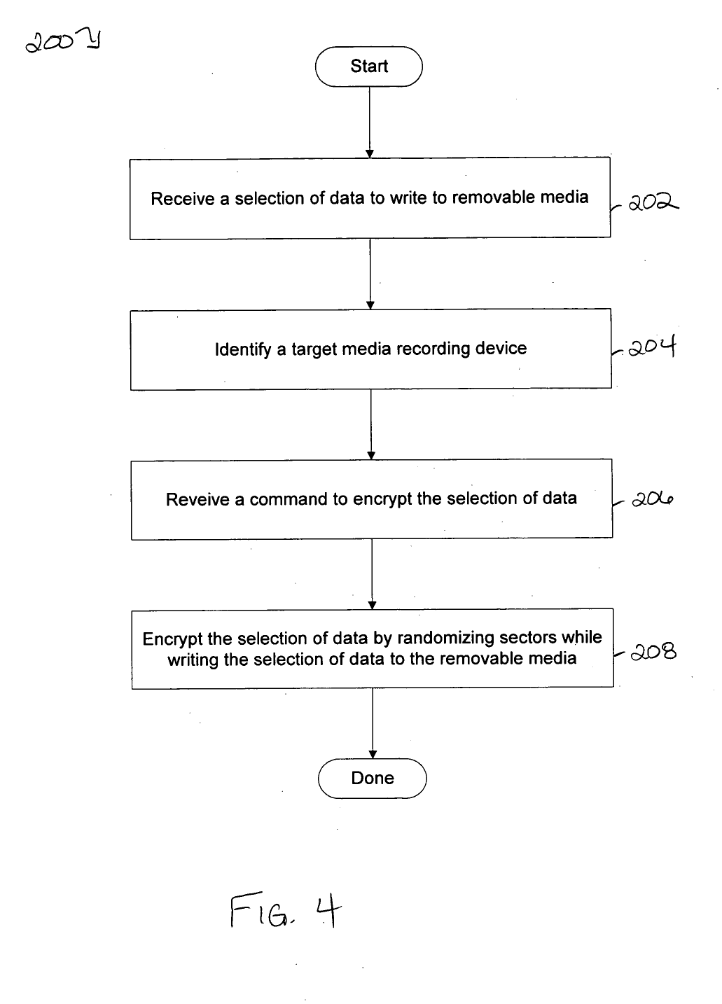

FIG. 4 is a flow chart diagram 200 of the method operations performed to encrypt a removable media in accordance with one embodiment of the present invention. The method begins with operation 202 in which a selection of data is received to write to a removable media. In one embodiment, the removable media is a CD optical media. In another embodiment, the removable media is a DVD optical media. In still other embodiments, the removable media is any other type of removable, block-structured, media including, but not limited to, floppy disk media. The selection of data to be recorded to the removable media can be accomplished in any manner implemented by a media recording program, “drag and drop” of data files, selection of a file to be copied or moved, etc.

The method continues with operation 204 in which a target media recording device is identified. In one embodiment, removable media is mounted in a media recording device, and the identification of the device to which the selection of data will be sent for recording can be as seamless and automatic as dragging files to an identified drive, or by more deliberate action such as selecting from one or more available media recording devices the target recording device for the selected data to be sent.

The method then proceeds with operation 206 in which a command is received to encrypt the selection of data. In one embodiment, a data recording application will prompt a user to select unencrypted or encrypted recording. In other embodiments, a user can set an option or preference to record the selected data in an encrypted state. The choice to encrypt data can be in any manner consistent with the particular system, media recording application, media recording device, etc. In operation 206, the command to encrypt the data is received to execute an encrypted recording of data.

The method concludes with operation 208 in which the selection of data is encrypted by randomizing sectors while writing or recording the selection of data to the removable media. In accordance with embodiments of the present invention, the encryption of data can be accomplished by simply randomizing the sectors, including the sectors containing the media file system, as they are written to the media. In one embodiment, as described above, an encryption algorithm or key is applied to a logical block address for each sector to calculate or determine a new or encrypted logical block address where the sector is actually written. Decryption, then, is the reverse. That is, if the encryption algorithm or key maps each unencrypted logical block address to an encrypted logical block address, then the encryption key or algorithm is used to determine or calculate the true or unencrypted logical block address for each sector of an encrypted disc. In other embodiments, data is first encrypted using a desired encryption algorithm, and then the sectors are randomized while writing to the target removable media.

In the embodiments illustrated by FIG. 4, the sectors are randomized as they are written to the target optical media. Because the randomized sectors include sectors having the file system and associated required file system structures, the media would fail to mount, and the media recording device would fail to recognize the media as a UDF format media, a DVD media, etc. If each data file or sector on the media were to be scrutinized or analyzed, it might be possible to access some part of the data recorded thereon, but, for example, every file that spans more than one sector or block will be only partially available or accessible as only one of the more than one sectors might have been accessed. Ultimately, data recorded to the removable media may be available in random bits, but complete file content, and perhaps more importantly, the content of the disk, file attributes, the size and location of each data file recorded to the media are rendered essentially meaningless, if located at all. With the encryption of the selection of data by randomizing sectors while writing the selection of data to the removable media, the method is done.

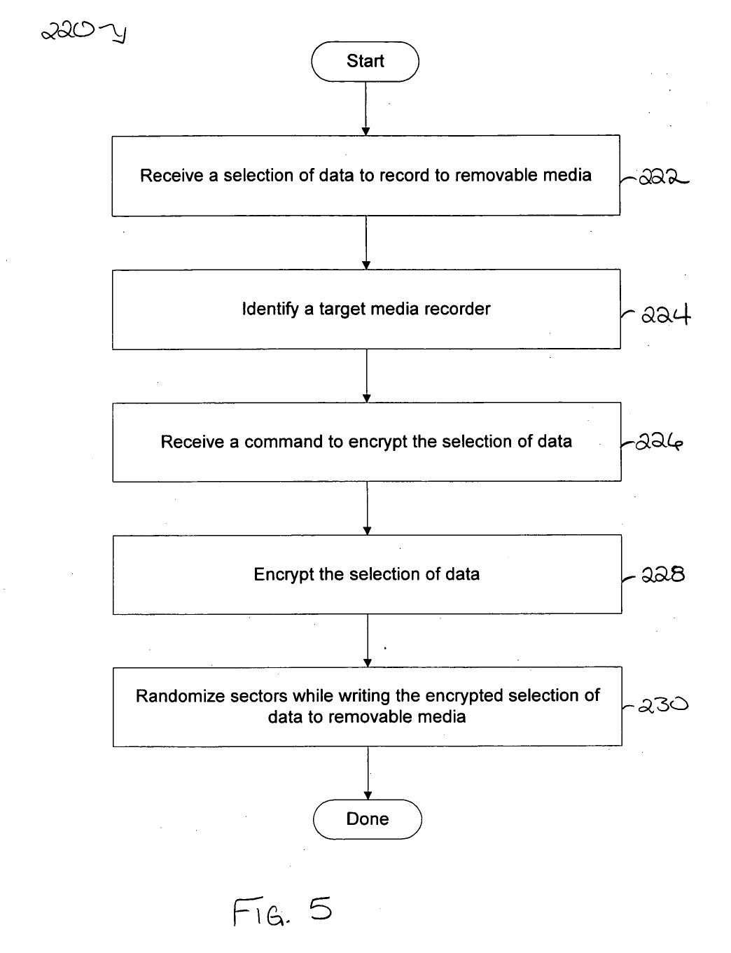

FIG. 5 is a flow chart diagram 220 of the method operations performed to encrypt a removable media in accordance with another embodiment of the present invention. The method illustrated in FIG. 5 is similar to that illustrated in FIG. 4, but affording an ever greater level or degree of security. The method begins with operation 222 in which a selection of data is received to write to a removable media. As described above in reference to FIG. 4, the media may be CD optical media, DVD optical media, or any other removable, block-structured, media including, but not limited to, floppy disk media. The selection of data to be recorded to the removable media can be accomplished in any manner implemented by a media recording program, “drag and drop” of data files, the selection and identification of a file to be copied or moved, etc.

The method continues with operation 224 in which a target media recording device is identified. As described above, the identification of the media recording device to which the selection of data will be sent for recording can be as seamless and automatic as dragging files to an identified drive, or by more deliberate action such as selecting from one or more available media recording devices the target recording device for the selected data to be sent.

The method then proceeds with operation 226 in which a command is received to encrypt the selection of data. As described above, a data recording application might prompt a user to select unencrypted or encrypted recording, or a user can set an option or preference to record the selected data in an encrypted state. The choice to encrypt data can be in any manner consistent with the particular system, media recording application, media recording device, etc. In operation 226, the command to encrypt the data is received to execute an encrypted recording of data.

Continuing with operation 228, the method provides for the encrypting of the data. In the illustrated embodiment, the selected data is first encrypted for a first layer or level of security before randomizing the sectors to achieve an additional layer of security. The encrypting can be according to any desired encryption algorithm or method, and can be accomplished in any method or manner consistent with the data recording application used to write the selected data to the target media recorder. The encrypted data, which in one embodiment includes the file system for the media, is then further encrypted according to an encryption algorithm or key to randomize the sectors written to the media. As described above, an encryption algorithm or key is applied to a logical block address for each sector to calculate or determine a new or encrypted logical block address where the sector is actually written. In one embodiment, sectors are written consecutively as units, i.e., as complete packets, with the location of entire packets randomized on the media. In one embodiment, sectors within packets are first randomized, and then the location of the packets is randomized when writing to the media. Decryption, then, is the reverse. That is, if the encryption algorithm or key maps each unencrypted logical block address to an encrypted logical block address, then the encryption key or algorithm is used to determine or calculate the true or unencrypted logical block address for each sector of an encrypted disc.

The method concludes with operation 230 in which the selection of data, now encrypted in operation 228, is written to the removable media and the sectors are scrambled or randomized during the writing. In accordance with embodiments of the present invention, security of the selected data is enhanced or increased by first encrypting the data, and then by randomizing the sectors, including the sectors containing the media file system, as they are written to the media. In one embodiment, the data is first encrypted before or as it is sent to the media recording device, and the media recording device randomizes the sectors as it writes the encrypted data to the target removable media. In another embodiment, a computing chip is on board the media recording device. Unencrypted data is received by the media recording device which then first encrypts the data, and then randomizes the sectors as it writes the data to the removable media. Once the encrypted data is written in randomized sectors to the removable media, the method is done.

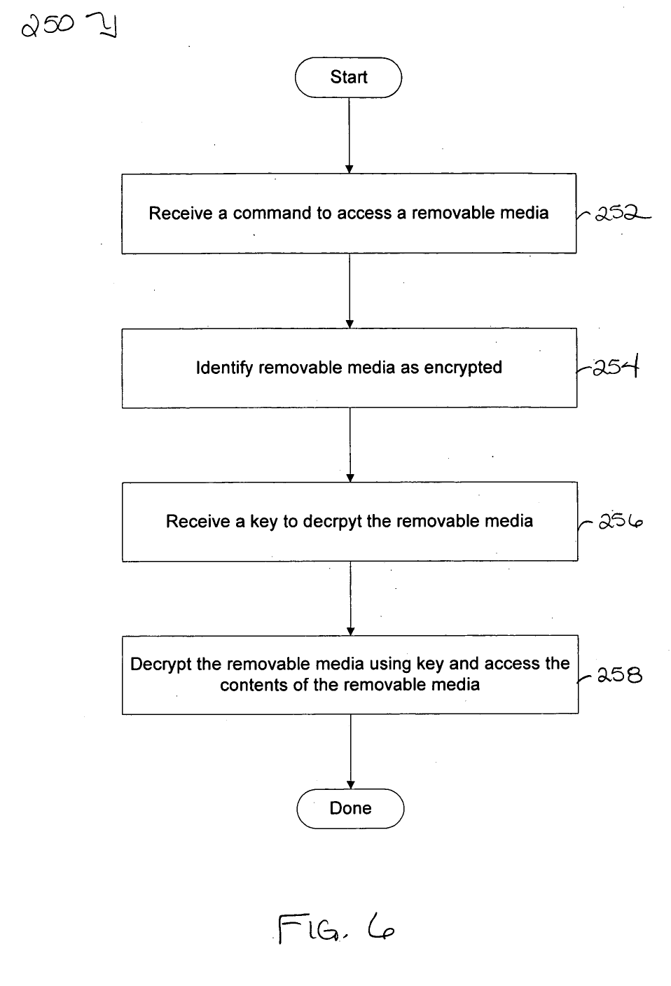

FIG. 6 is a flow chart diagram 250 illustrating the method operations performed to decrypt data on removable media in accordance with one embodiment of the present invention. The method begins with operation 252 in which a command is received to access a removable media. In one embodiment, the command is automatically executed or issued by inserting a removable media into a removable media device. In other embodiments, the command is received as a result of selecting a removable media device, a drive, or some other source designation according to the particular system configuration, operating system, etc., requesting access to a media located therein.

The method continues with operation 254 in which the removable media is identified as being encrypted. In one embodiment, the removable media, encrypted in accordance with embodiments of the present invention, fails to mount. Upon receipt of the request or command to access the removable media, the media device attempts to mount the removable media. In one embodiment of the invention, before the removable media can proceed to a booting, loading, or mounting sequence, the removable media is identified to the media device that it is encrypted.

In one embodiment, the removable media includes in a non-addressable sector (i.e., the Lead-In on CD/DVD media, and reported via the data returned in response to the ReadDiscInfo command, etc.) identification of the media as encrypted which would trigger a prompt for a decryption key. As is known, a Lead-In is specified to be a certain number of blocks in length. The number of blocks varies according to the specific type of media, whether it is a first session or subsequent session on the media, etc. The first Lead-In on a media is very well defined, and contains “reserved” blocks or fields. In one embodiment of the present invention, one or more of the specified reserved blocks or fields is implemented to indicate encryption according to the present invention. Such a block or field can be implemented to issue or trigger a prompt for a decryption key, trigger an encryption or decryption routine, etc. In one embodiment, for example, upon identification of a media as encrypted, a host system might prompt the user for a key or password. When the key or password is supplied, the media then supplies blocks of data that have been decrypted and re-arranged according to the proper logical block address, with or without further intervention by the host system. In other embodiments, identification may be implemented in a first or last block of the media, through a separate security application (program), or in any other manner consistent with known media formatting specifications and standards.

In operation 256, a key is received to decrypt the removable media. In one embodiment, the key is received in response to a prompt or query for a decryption key following the identification of the media as encrypted. In another embodiment, the removable media might be physically identified as encrypted (e.g., with an identifying mark, logo, or other such symbol on a face of, or on a jacket or sleeve for, the media) with an accompanying instruction for a specific load or boot sequence to generate the prompt. Embodiments of the key received are according to known methods and practices for decrypting encryption algorithms, and can include alpha-numeric codes to be input, or a file path to a decryption location, or a web address, an encryption certificate, etc.

The method concludes with operation 258 in which the removable media is decrypted using the key received, and access is provided to the data written to the removable media. In one embodiment, a supplied numeric algorithm generates the mapping for any given sector location to decrypt the media. In one embodiment the key unlocks a map to the randomized sectors, identifying a actual location for each sector. The media device can then access the ADVP and proceed to mount the removable media. In one embodiment, once the media has been decrypted to identify the actual location of the sectors on the media, the data is fully accessible and usable as written to the media. In another embodiment, once the actual location of the sectors of data are identified, the raw data must then be decrypted in order for it to be usable. In this embodiment, a second prompt issues to request a key to decrypt the encrypted data on the removable media. In one embodiment the same key is implemented to encrypt and decrypt both the sector locations as well as the data, and only one prompt for a key is issued. Once the data on the removable media is accessible, the method is done.

The invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of computer readable media include hard drives, network attached storage (NAS), read-only memory, random-access memory, CD-ROMs, CD-Rs, CD-RWs, DVD-ROM, DVD-R/RW, DVD-RAM, DVD+R/+RW, magnetic tapes, floppy disks, and other optical and non-optical data storage devices. The computer readable medium can also be distributed over a network coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for encrypting a block-based removable media, comprising:
receiving a selection of data to write to the block-based removable media;
identifying true logical block addresses on the block-based removable media to which the selection of data will be associated;
assigning encrypted logical block addresses according to a first encryption algorithm, the encrypted logical block addresses having corresponding unencrypted true logical block addresses; and
writing the selection of data to the block-based removable media, the writing being to the encrypted logical block addresses,
wherein when the selection of data is located on the block-based removable media according to the true logical block addresses, the block-based removable media is enabled to provide access to the selection of data recorded thereon.

2. The method of claim 1, further comprising:
encrypting the selection of data according to a second encryption algorithm, wherein locating the selection of data is enabled by decryption according to the first encryption algorithm and access to the selection of data is enabled by decryption according to the second encryption algorithm.

3. The method of claim 1, wherein the block-based removable media is CD media.

4. The method of claim 1 wherein the block-based removable media is DVD media.

5. The method of claim 1, further comprising:
identifying a file system to define the block-based removable media; and
writing the file system to the block-based removable media, the writing being according to the encrypted logical block addresses.

6. The method of claim 5, wherein the file system is Universal Disc Format (UDF).

7. The method of claim 1, wherein the first encryption algorithm is implemented in hardware, the hardware being a computing chip implemented in a media recording device.

8. The method of claim 2, wherein the second encryption algorithm is implemented in software.

9. The method of claim 5, wherein the writing of the file system and the selection of data to the block-based removable media is accomplished by packet writing.

10. A method for encrypting a block-based removable media, comprising:
identifying a file system for the block-based removable media;
identifying a selection of data to write to the block-based removable media;
identifying physical block locations on the block-based removable media to which the file system and the selection of data will be associated, the physical block locations being identified according to the identified file system;
assigning encrypted physical block locations according to a first encryption algorithm with each physical block location identified for the file system and the selection of data corresponding to an encrypted physical block location; and
writing the file system and the selection of data to the block-based removable media, the writing being to the encrypted physical block locations,
wherein when the file system and the selection of data are located according to the physical block location, the block-based removable media is enabled to provide access to the selection of data recorded thereon.

11. The method of claim 10, further comprising:
encrypting the selection of data according to a second encryption algorithm, wherein locating the file system and the selection of data is enabled by decryption according to the first encryption algorithm and access to the selection of data is enabled by decryption according to the second encryption algorithm.

12. The method of claim 10, wherein the block-based removable media is CD media.

13. The method of claim 10 wherein the block-based removable media is DVD media.

14. The method of claim 10, wherein the file system is Universal Disc Format (UDF).

15. The method of claim 10, wherein the writing of the file system and the selection of data to the block-based removable media is accomplished by packet writing.

16. Computer readable media having program instructions for encrypting removable media, the computer readable media comprising:
program instructions for preparing a selection of data to write to the removable media;
program instructions for identifying true logical block addresses on the removable media to which the selection of data will be associated;
program instructions for assigning encrypted logical block addresses according to a first encryption algorithm with each true logical block address identified for the selection of data corresponding to an encrypted logical block address; and
program instructions for writing the selection of data to the removable media, the writing being to the encrypted logical block addresses,
wherein when the selection of data is located according to the true logical block addresses, the removable media is enabled to provide access to the selection of data recorded thereon.

17. The computer readable media according to claim 16, further comprising:
program instructions for defining a file system on the removable media;
program instructions for identifying true logical block addresses on the removable media to which the file system will be associated; and
program instructions for assigning encrypted logical block addresses according to a first encryption algorithm with each true logical block address identified for the file system corresponding to an encrypted logical block address.

18. The computer readable media according to claim 16, further comprising:
program instructions for encrypting the selection of data according to a second encryption algorithm, wherein locating the selection of data is enabled by decryption according to the first encryption algorithm and access to the selection of data is enabled by decryption according to the second encryption algorithm.

19. The computer readable media according to claim 17, further comprising:
program instructions for defining the file system and writing the selection of data to the removable media by packet writing.

20. The computer readable media according to claim 17, wherein the file system is UDF.

21. A method for encrypting data written to optical media, comprising:
receiving a selection of data to write to the optical media;
identifying true logical block addresses on the optical media to which the selection of data will be associated;
defining encrypted logical block addresses according to a first encryption algorithm, the encrypted logical block addresses having corresponding unencrypted true logical block addresses;
writing the selection of data to the optical media, the writing being to the encrypted logical block addresses; and
identifying the optical media as encrypted, the identifying including defining a field in a first Lead-In of the optical media to identify the optical media as encrypted,
wherein when the selection of data is located on the optical media according to the true logical block addresses, the optical media is enabled to provide access to the selection of data recorded thereon.

22. The method of claim 21, further comprising:
encrypting the selection of data according to a second encryption algorithm, wherein locating a file system and the selection of data is enabled by decryption according to the first encryption algorithm and access to the selection of data is enabled by decryption according to the second encryption algorithm.

23. The method of claim 21, wherein the optical media is CD media.

24. The method of claim 21 wherein the optical media is DVD media.
